(19) United States
(12) Patent Application Publication
(10) Pub. No.: US 2016/0266021 A1
(43) Pub. Date: Sep. 15, 2016

(54) WIRELESS WEAR MONITORING FOR CONDUITS

(71) Applicant: SYNCRUDE CANADA LTD. in trust for the owners of the Syncrude Project as such owners exist now and, Fort McMurray (CA)

(72) Inventors: SOON WON MOON, Edmonton (CA); STEWART JOHNSON, Edmonton (CA); KHALED OBAIA, Edmonton (CA)

(21) Appl. No.: 15/056,497

(22) Filed: Feb. 29, 2016

(30) Foreign Application Priority Data
Mar. 11, 2015 (CA) 2885649

(51) Int. Cl. G01N 3/56; F16L 57/06; G06K 19/077; H04Q 9/00; F16L 55/26

(52) U.S. Cl. CPC G01N 3/56; H04Q 9/00; F16L 55/26; G06K 19/07798; F16L 57/06; H04Q 2209/40; F16L 2101/30

(57) ABSTRACT

A conduit includes at least one tag having a known location, or a plurality of tags having different longitudinal or radial locations or depths, wherein each tag is responsive to a reader to uniquely identify itself. A wear monitoring method and system includes a tag reader and a processor which executes instructions to compare the presence of each tag identified by the reader with a list of all tags initially present in the conduit.

### FIELD OF THE INVENTION

The present invention relates to wireless wear monitoring for conduits, including hoses and lined pipes.

### BACKGROUND

Mining products are frequently transported as slurries in conduits such as pipes and hoses, which causes considerable wear within the conduit. Large rubber mining hoses are often used due to their flexibility and high wear performance as such hoses have comparatively better wear properties than metal pipes, particularly unlined metal pipes. Flexible hoses are generally multilayered, comprising an inner liner, a reinforcement layer and a cover, with the reinforcement layer sandwiched between the liner and the cover. Both liner and cover can be made of synthetic or natural rubbers, polyurethane, or other polymers.

Metal pipes and pipelines are relatively inflexible, but may have a polymer liner for internal wear resistance.

There is a need to be able to non-destructively test or monitor the deterioration of the inner surface liner of hoses or lined pipes. In one prior art solution, a continuity wire may be used in a a rubber hose or pipe liner. Generally, rubber hoses are fabricated on a mandrel, where sheets of uncured rubber are wrapped onto the mandrel to form a liner with a specified thickness, followed by wrapping reinforcement fabric layers and cover. Continuity wires are embedded in the liner by placing them between different rubber sheets. Typically, a single continuity wire is spirally wound to cover the entire body of the rubber hose. The single continuity wire can be embedded at a single liner depth or at multiple liner depths. A check point is provided, for example, an area where the wire is accessible from the surface/outside of the rubber hose, and a current is connected thereto to determine whether the current can be detected throughout the length of the rubber hose.

However, there are problems associated with having a single continuity wire covering the entire body of the conduit. There is only a limited monitoring capability, i.e., only a one-time check, as once the wire breaks down in one location, the monitoring capability is lost in all other locations. Thus, this solution does not support a pipe or hose rotation strategy, as once the wire breaks down due to wear in one position, these rubber hoses and lined pipes lose wear monitoring capability in all other positions. Thus, after a single pipe rotation, no wear monitoring capability is left. In addition, the current continuity wire system does not provide location-specific wear information; the damage on the wire only indicates wear occurred somewhere, not knowing the exact wear location. Furthermore, the metallic continuity wire may be less flexible compared to most rubbers, so the wire may break during excessive handling of rubber hoses.

Therefore, there is a need in the art for a conduit configuration with a wear monitoring system which may provide increased inspection life, location-specific wear information and/or improved durability.

### SUMMARY OF THE INVENTION

In one aspect, the invention may comprise a conduit comprising at least one tag having a known location and depth, or a plurality of tags each having a different longitudinal or radial location or depth, wherein each tag is responsive to a reader to uniquely identify itself. The tag may comprise a radio-frequency identification (RFID) tag, a near field communication (NFC) target, or similar tag employing wireless communication technology.

In one embodiment, the conduit may comprise a rubber hose. In another embodiment, the conduit may comprise a pipe having a polymer liner. The conduit can be a conduit made of a uniform material or can be a conduit comprising multiple layers.

In another aspect, the invention may comprise a method of monitoring wear in a conduit, comprising the steps of (a) providing a conduit comprising at least one tag having a known location or depth, or a plurality of tags each having a different longitudinal or radial location or depth, wherein each tag is responsive to a reader to uniquely identify itself; (b) scanning the conduit with the reader; and (c) determining the location of wear, if any, in the conduit by determining the presence or absence of a tag. The tag may comprise a RFID tag or an NFC target, or similar tag employing wireless communication technology.

In one embodiment, the conduit may comprise a rubber hose and the wear monitoring can be conducted manually by using a portable reader or automatically by placing external accessory antennas onto or around the conduit. The antennas may then be connected to remote readers for automatic reading, which may comprise general purpose computers operating suitable software. In one embodiment, the method may comprise a step of producing a visual spatial representation of each tag or missing tag, which may provides a visual approximation of the conduit itself. Since radio frequency waves can penetrate through the wall thickness of rubber hoses, the scanning of RFID tags can be conducted both internally and externally.

In one embodiment, where the conduit comprises a metal pipe having a non-metallic liner which has at least one tag having a known location or depth, the method may comprise the step of inserting a reader into the pipeline to determine the presence or absence of the at least one tag. The reader may be self-propelled or pushed through the length of the pipe using fluid pressure. The reader may be attached or built-in to a smart pig or a robot for internal scanning. Since radio frequency waves cannot penetrate the metallic shell, the scanning of RFID tags can be conducted internally only.

In another aspect, the invention may comprise a wear monitoring system for use with a conduit comprising at least one tag having a known location or depth, or a plurality of tags each having a different longitudinal or radial location or depth, wherein each tag is responsive to a reader to uniquely identify itself, the system comprising:
(a) a tag reader adapted to scan the conduit and identify each tag present in the conduit and store a list of those tags;
(b) a processor; and
(c) a memory operatively connected to the processor and storing a set of instructions executable by the processor to compare the presence of each tag identified by the reader with a list of all tags initially present in the conduit.
   The tag may comprise a RFID tag or an NFC target. The conduit may comprise a rubber hose. The wear monitoring can be conducted manually by using a portable reader or automatically by placing one or more external accessory antennas onto or around the conduit. The external accessory antennas may be connected to a remote reader device, such as a general purpose computer operating suitable software for automatic reading.

In one embodiment, the conduit may comprise a metal pipe with a liner, wherein the tags are embedded in the liner at known depths and locations. In this embodiment, the tag reader may be a device adapted to travel within the pipe, and may be self-propelled, or pushed through the length of the pipe by fluid pressure. The reader may be attached or built-in to a smart pig or a robot for internal scanning.

In one embodiment, the system instructions executable by the processor further results in the visual display of each tag, or each missing tag, or both, in a virtual representation of the conduit.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention, However, one skilled in the art will understand that portions of the example or aspect may be used in combination with other examples or aspects of the invention.

FIG. 1 shows a schematic representation of one embodiment of a wear monitoring system, with a virtual representation of a hose having a plurality of tags.

FIG. 2 shows a schematic representation of a conduit liner having tags at different depths, and the progressive wear of the conduit liner over time, resulting in the loss of certain tags.

FIG. 3 shows a schematic representation of an alternative embodiment of a wear monitoring system, showing an accessory antenna device operatively connected to a remote reader system.

FIG. 4 is a schematic representation of one embodiment of a wear monitoring system of the present invention.

FIGS. 5A and 5B shows cross-sections of a pipeline having a liner with embedded tags.

FIG. 6 shows the pipeline of FIG. 5A with one embodiment of a smart pig RFID sensor.

FIG. 7 shows a schematic representation of a pipeline have a lined non-metallic section and an unlined metallic section.

### DETAILED DESCRIPTION

As used herein, the recited terms have the following meanings. All other terms and phrases used in this specification have their ordinary meanings as one of skill in the art would understand.

To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The present invention comprises a wireless wear monitoring system comprising a conduit having at least one tag having a known location or depth, or a plurality of tags embedded in the conduit having different locations and depths, which tags may be sensed wirelessly and identified by a tag reader. Although the present specification refers mainly to a rubber hose or a pipe with a polymer liner, one skilled in the art will recognize that the invention may successfully be applied to any conduit made of a natural or synthetic material. Certain embodiments of the present invention are well suited to conduits which allow radio frequency waves to pass through.

Embodiments of the present invention may preferably be used with polymeric, plastic or composite pipes or hoses, such as rubber, polyurethane, polyethylene, or composite hoses or pipes with multiple layers along the pipe wall thickness, such as fiber-reinforced plastic (FRP) pipes. In one embodiment, the conduit is a flexible hose comprising a polymeric liner, such as a rubber or elastomeric liner.

Other embodiments are well suited to conduits which are opaque to radio frequency waves, such as metal pipes and pipelines. In such cases, the tag readers must be positioned internal to the conduit. Therefore, the conduit may comprise a metal pipeline having a non-metallic lining having at least one tag having a known location or depth. As used herein, a “pipeline” is a continuous piping conduit which may be formed from a plurality of pipes joined end to end.

As used herein, the term “wireless” shall mean that the communication between the tag or tags and the tag reader is wireless. The tag reader itself may comprise an antenna which is operatively connected to a remote reader device, which itself may be operatively connected to a monitoring system,

In another aspect, the invention may comprise a wear monitoring system for a non-conduit structure, such as a plate, trough, container, tank or the like, which may be subject to variable wear as a result of a flowing fluid. The principles of the present invention as described herein in relation to a conduit may be applied by one skilled in the art to such a non-conduit structure.

The tags are adapted to be identifiable by a sensor or a tag reader. In one embodiment, the tags may comprise RFID tags, each with a data string comprising an identification code. The embedded tags are responsive to the reader, which operates to identify each RFID tag by wirelessly interrogating it. The reader comprises an antenna as is well known in the art. Thus, a conduit may be periodically scanned using a reader, either on an ad hoc basis, or in accordance with a pre-determined inspection schedule. If all tags are detected, then it may be concluded that no significant wear has occurred. If a particular tag is missing, then it may be concluded that the conduit has eroded in the particular location and depth of the missing tag.

The reader may be a portable handheld device 40 with a built-in antenna. In manual reading, the tag antenna and the reader antenna communicate each other. In an alternative embodiment, an external accessory with one or more antennas may placed onto or around the conduit, which antennas may be wired or otherwise communicate with a remote reader system. The remote reader system may comprise a general purpose computer system operating suitable software. The remote reader system may enable automatic readings and data collection. The external accessory can be in the form of a patch or a ring. Automatic reading may allow wear monitoring in locations where manual reading is difficult to achieve.

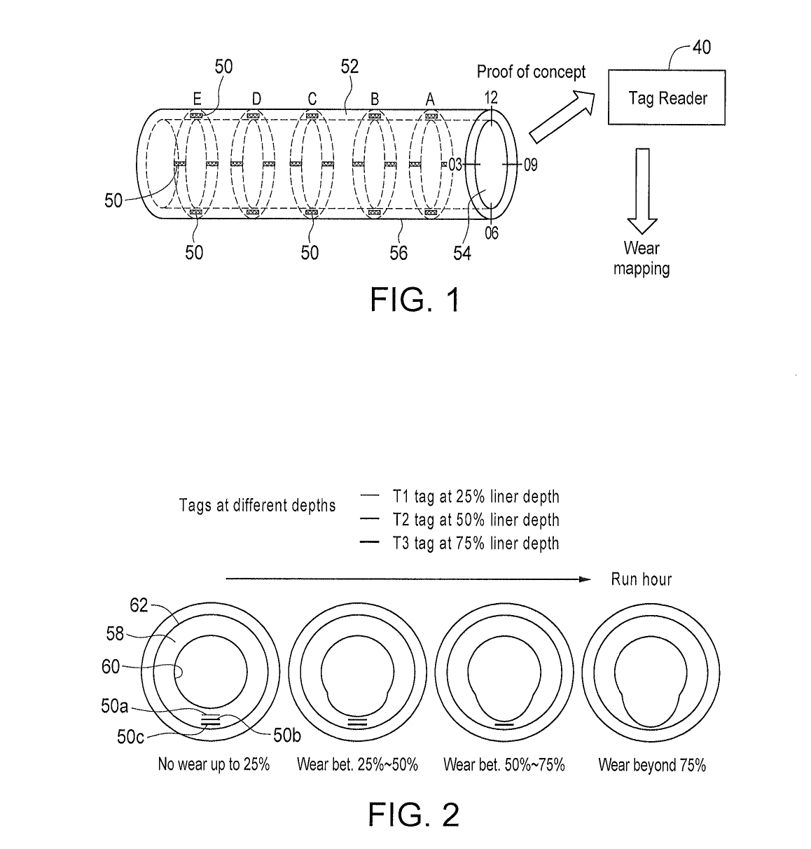

As shown schematically in FIG. 1, a plurality of tags 50 are embedded in a rubber hose 52, each located in a different location. As may be seen, the tags 50 may be separated by a longitudinal dimension, meaning that they are located at different locations along the length of the hose. Different longitudinal locations are indicated by the letters A to E. As well, the tags may be separated by a radial dimension, meaning that they are located at different locations along an imaginary transverse plane through the hose. In that instance, the radial location may be denoted using a clock position, i.e., four tags having the same longitudinal location may be positioned at 3, 6, 9 and 12 o'clock. In one embodiment, the tags 50 are located between the inner surface 54 of the hose 52 and the outer surface 56.

In one embodiment, tags may be provided at different depths in the same longitudinal and radial location. As used herein, “depth” means the wall thickness of the conduit, or, in the case of a lined conduit, the thickness of the liner. A tag having a different depth than another tag will be closer or farther away from the axial centre of the conduit. In this manner, the extent of erosion or damage may be known in a particular location.

As shown in FIG. 2, three separate tags, 50a, 50b and 50c, are embedded at different depths in a liner 58 of a conduit, at the same radial and longitudinal location, with tag 50a being the closest to the inner surface 60 of the liner and tag 50c being closer to the outer surface 62 of the liner. The inner surface 60 is where erosion will occur as a slurry is continuously pumped through the conduit. As the run hours of the conduit increase, the inner surface 60 begins to erode at the 6 o'clock position. It can be seen that tag 50a has eroded away when the liner 58 experiences wear between 25˜50%, and, as such, will no longer be responsive to a reader. At this point, the operator will be aware of the degree/depth of erosion that has taken place in that tags 50b and 50c are still responsive, but tag 50a is not. The operator may choose to continue operating the conduit until tag 50b is no longer detectable by the system. At this point, more extensive erosion of the inner surface 60 of the liner 58 has occurred and the operator may choose to continue operating the conduit until tag 50c is lost, rotate the conduit 90 degrees or 180 degrees, or replace the conduit 60.

If the system does not detect tag 50c, then it may be concluded that the liner 58 has worn beyond 75% at that location, and that immediate rotation, replacement or repair may be necessary.

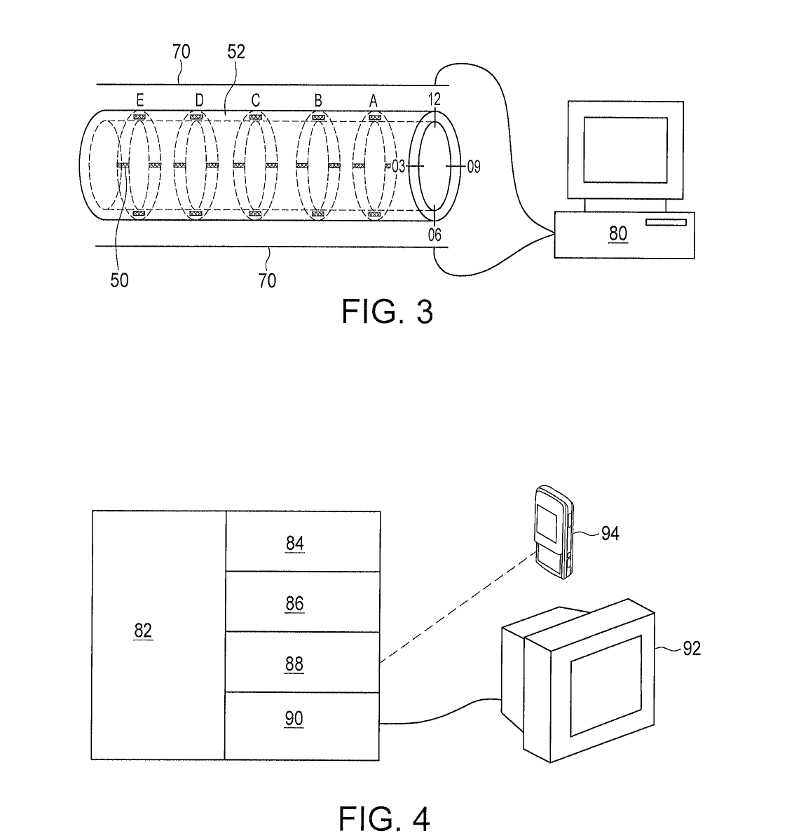

As shown in FIG. 3, in one embodiment, an external accessory comprising an antenna 70 is located in close proximity to the hose 52. Although the antenna 70 is shown being extended in the longitudinal direction, the antenna or plurality of antennas may exist in any configuration, in the vicinity of the tags. For example, in one embodiment, the antenna may be placed around the circumference of the hose in a ring-like configuration. Alternatively, a plurality of smaller antennas may placed adjacent to each tag, or each tag location. The antennas are operatively connected to a tag reader, which itself is connected to or is comprised in a general purpose computer 80 operating suitable software.

In one embodiment, the collected data may be processed and graphically displayed with computer software tools. Thus, the invention may comprise a wear monitoring system for use with a conduit comprising single or a plurality of tags having different longitudinal or radial locations or depths, wherein each tag is responsive to a reader to uniquely identify itself, said system comprising:
(a) a tag reader 40 adapted to scan the conduit and identify each tag present in the conduit;
(b) a processor 82; and
(c) a memory 84 operatively connected to the processor and storing a list of all tags initially present in the conduit, and a set of instructions executable by the processor to compare the presence of each tag identified by the reader with a list of all tags initially present in the conduit.

In this way, convenient, location-specific wear monitoring can be achieved. The system may be configured to continuously monitor the conduits or may monitor the conduits on a regular or irregular periodic schedule, for example, once daily. The system may include a component 86 configured to automatically generate a wear report which may be stored or transmitted to a user or operator. The system may also include a component 88 configured to raise an alarm or send a message to a user or an operator if abnormal or excessive wear has occurred, for example, an email or a text message to a cell phone 94.

Each tag, which is individually identifiable is associated with a particular location and depth, therefore, the system may include a component 90 configured to graphically display the location of all the tags on a monitor 92, which provides a visual approximation of the conduit itself, or a portion of the conduit.

The tag reader 40, processor 82 and memory 84 may be self-contained in a portable device, such as a tablet computer or smartphone.

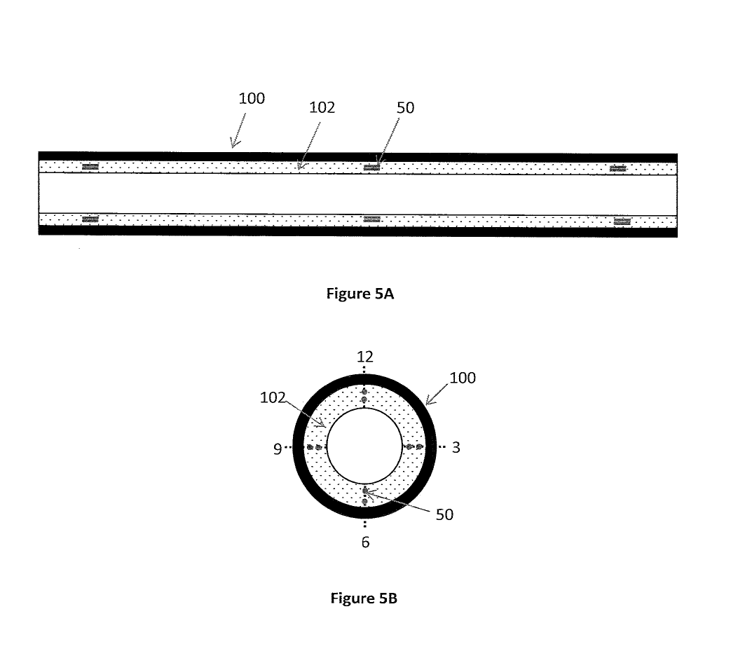

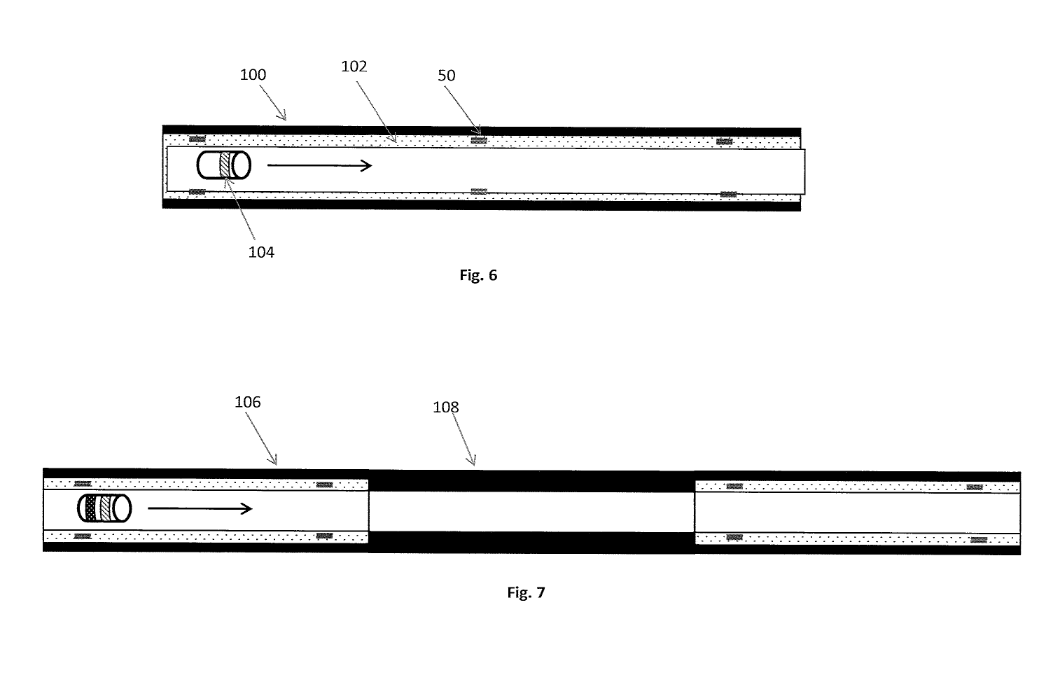

As shown schematically in FIGS. 5A and 5B, an embodiment of the present invention may be adapted for use in a radio frequency opaque conduit, such as a metal pipeline 100 having a polymer liner 102. The tags 50 are disposed within the liner in the same manner as described above. The tag reader comprises a device 104 which may travel or be displaced within the pipeline.

The device 104 may comprise a pipeline pig or a “smart pig”, as is known in the art of pipeline pigging. Conventional smart pigs are inspection devices which record information about the internal conditions of a pipeline, and may include sensors such as magnetic flux leakage sensors. Pipeline pigs are well-known in the art and need not be further described herein. In embodiments of the present invention, the smart pig 104 comprises a tag reader component which senses the existence of the tags 50 and records their presence or absence. Accordingly, once the smart pig 104 has travelled the length of the pipeline, the presence or absence of certain tags 50 will provide information about the location and depth of wear of the liner 102. The pig 104 may also comprise a processor 82 and a memory 84, as described above.

In one embodiment, the smart pig 104 may include other sensors known in the art to inspect and record data regarding all-metallic sections (108) of the pipeline as well as the polymer lined section (106), as is shown conceptually in FIG. 7. Thereby, single pig run can collect all wear data for a pipeline composed of different piping materials.

Smart pigs are propelled by fluid pressure in the pipeline. In alternative embodiments, the device 104 may comprise a self-propelled robot. Pipeline inspection robots are well-known in the art, and need not be further described herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “system.” Furthermore, aspects of the present invention may take the form of a computer program product embodied in one or more computer readable medium(s) having computer readable program code embodied thereon,

Computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts described herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The wear monitoring methods of the present invention may be incorporated into conduit rotation strategies, or other wear preventative measures.

The method of embedding tags in a conduit, with or without a liner, is well within the routine skill of one skilled in the art, using well-known and conventional techniques.

RFID technology is also well known and described in the art—see “RFID Essentials” 2006, Bill Glover, O'Reilly Media, Inc., or “RFID Technology and Applications, 2008, Stephen Miles ed., Cambridge University Press, the entire contents of both which are incorporated herein, where permitted. Suitable alternative technologies may include near field communication (NFC) or other short range wireless technologies. The essential element of the tags and readers is only that the reader be capable of wirelessly identifying each tag. Preferably, the reader acts as an interrogator or initiator, which each tag is a passive target or transponder.

### Definitions and Interpretation

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A conduit comprising at least one tag having a known location and responsive to a reader to uniquely identify itself.

2. The conduit of claim 1 comprising a plurality of tags each having a different longitudinal location, radial location or depth.

3. The conduit of claim 1 wherein each tag is a radio frequency identification (RFID) tag.

4. The conduit of claim 1 wherein the conduit is a rubber hose.

5. The conduit of claim 1 wherein the conduit is a pipeline having a polymer liner.

6. A method of monitoring wear in a conduit, comprising the steps of (a) providing a conduit comprising at least one tag having a known location and responsive to a reader to uniquely identify itself; (b) scanning the conduit with the reader; and (c) determining the location of wear, if any, in the conduit by determining the presence or absence of the at least one tag.

7. The method of claim 6 wherein the conduit comprises a plurality of tags each having a different longitudinal or radial location or depth.

8. The method of claim 6 wherein each tag is an RFID tag.

9. The method of claim 6 wherein the conduit is a rubber hose.

10. The method of claim 6 wherein the conduit is a pipeline having a polymer liner.

11. The method of claim 6 wherein the reader is propelled within the pipeline by fluid pressure.

12. The method of claim 6 wherein the reader is attached or built-in to a smart pig or a robot for internal scanning.

13. The method of claim 6 wherein the reader is a portable handheld unit and the wear monitoring is conducted manually.

14. The method of claim 9 wherein the reader comprises an antenna placed onto or around the conduit operatively connected to a remote reader apparatus.

15. The method of claim 6 wherein the wear monitoring is conducted automatically on a continuous basis or a periodic basis.

16. The method of claim 15 wherein a wear report is automatically generated and/or, if abnormal or excessive wear has occurred, an alarm is raised or a message generated and sent.

17. The method of claim 6 wherein further comprising the step of visually displaying each tag, or each missing tag, or both, in a virtual representation of the conduit.

18. A wear monitoring system for use with a conduit comprising at least one tag having a known location, or a plurality of tags each having a different longitudinal or radial location or depth, wherein each tag is responsive to a reader to uniquely identify itself, said system comprising:
(a) a tag reader adapted to scan the conduit and identify each tag present in the conduit;
(b) a processor; and
(c) a memory operatively connected to the processor and storing a list of all tags initially present in the conduit and a set of instructions executable by the processor to compare the presence of each tag identified by the reader with a list of all tags initially present in the conduit.

19. The system of claim 18 wherein each tag is a radio frequency identification (RFID) tag.

20. The system of claim 18 wherein the tag reader is a portable handheld unit with an integral antenna, or comprises an antenna placed onto or around the conduit operatively connected to a remote reader apparatus.

21. The system of claim 18 wherein the wear monitoring is conducted automatically on a continuous basis or a periodic basis.

22. The system of claim 18 wherein the tag reader is attached or built-in to a smart pig or a robot.

23. The system of claim 21 wherein the instructions executable by the processor further results in the generation of a wear report and/or, if abnormal or excessive wear has occurred, the generation of an alarm and/or a message.

24. The system of claim 18 wherein the instructions executable by the processor further results in the visual display of each tag, or each missing tag, or both, in a virtual representation of the conduit.
